(19) United States
(12) Patent Application Publication
(10) Pub. No.: US 2017/0282948 A1
(43) Pub. Date: Oct. 5, 2017

(54) BALANCE MAINTAINING DEVICE FOR TRANSPORT APPARATUS, AND TRANSPORT APPARATUS PROVIDED WITH SAID BALANCE MAINTAINING DEVICE

(71) Applicant: Seok U BAE, Chilgok-gun, Gyeongsangbuk-do (KR)

(72) Inventor: Seok U BAE, Chilgok-gun, Gyeongsangbuk-do (KR)

(21) Appl. No.: 15/503,697

(22) PCT Filed: Aug. 13, 2015
(86) PCT No.: PCT/KR2015/008524

§ 371 Date: Feb. 13, 2017

(30) Foreign Application Priority Data
Aug. 14, 2014 (KR) 10-2014-0105800
Aug. 14, 2014 (KR) 10-2014-0105832

(51) Int. Cl. B62B 1/20; F16M 11/12; B63B 43/02; B62D 33/02; B63B 39/04

(52) U.S. Cl. CPC B62B 1/20; B62D 33/02; B63B 39/04; B63B 43/02; F16M 11/12; B63B 39/00

(57) ABSTRACT

The present invention relates to a balance maintaining device for a transport apparatus. The balance maintaining device comprises a loading frame formed to be long in the lengthwise direction thereof and having two or more first and second supports, which are respectively formed at both sides of the lower portion of the loading frame, and a lower frame provided at the lower portion of the loading frame, and having both upper sides thereof linked and coupled to the first and second supports. The outside of the lower frame is coupled to a transport apparatus so as to maintain the loading frame in a horizontal state when the transport apparatus is shaken.

### TECHNICAL FIELD

The present invention relates to a balance maintaining device for a transport apparatus and a transport apparatus provided with said balance maintaining device and, more particularly, to a balance maintaining device for a transport apparatus and a transport apparatus provided with said balance maintaining device, in which, when a transport apparatus moves on an uneven ground surface or sea after loading cargo, the cargo loaded in a loading box can be maintained in balance without shaking so as not to escape, the gravity point of the loaded cargo is moved to a lower portion of the transport apparatus so as to ensure safe operation of the transport apparatus, and the power of a ship is generated by the vibration of the ship due to the influence of waves.

### BACKGROUND ART

Generally, the operation of various transportation means such as a car, which is a land transportation apparatus, is shaken and tilted due to the flatness of the ground surface, resulting in the danger of overturning and uncomfortable riding, and a ship, which is a transport apparatus of sea and river, is shaken and tilted according to the height of the waves, resulting in the risk of sinking and causing the seasickness of passengers.

Recently, a ship which had been operated in the sea was completely sunk into the sea due to the tilting of the loaded cargo, which was loaded on the ground surface, in one side direction due to the high waves. This accident caused massive loss of lives and huge economic losses.

First, considering prior art, Korean registered patent No. 10-1147624 discloses a balance maintaining device for a ship, which can float and move on the surface of water while holding people, livestock and materials, and includes buoyancy tank parts provided at both side parts of the ship, positioned on the waterline drawn on both side surfaces of the ship and extended from the front end to the rear end of the ship, thereby restoring the ship, which leans to one side, to an initial state thereof and maintaining the balance of the ship. The buoyancy tank part includes: an outside part having a double pipe part, which is formed in a semi-cylindrical double pipe shape with an empty inner portion, and a reinforcing portion, which is applied onto the outer surface of the double pipe part in a state, in which the fiber reinforced plastic is laminated; and semi-circular partition walls having the same shape as the side portion shape of the outside part and respectively coupled to the both side portions of the outside part, wherein a plurality of the buoyancy tank parts having the above structure are provided and spaced from each other at predetermined intervals, the partition wall is coupled to one side of the outside part of each of the buoyancy tank parts, which are located at the outermost side positions among the plurality of buoyancy tank parts, and the other side of the outside part of each of the buoyancy tank parts, which are located at the outermost side positions among the plurality of buoyancy tank parts, is rounded into a streamline shape.

The above described prior art is configured to maintain the balance of a ship by providing the buoyancy tank parts at both sides of the ship, but has a problem that, when the ship is tilted to one side or the other side by the waves, the loaded cargo is shifted to one side or the other side in the ship, resulting in the sinking of the ship into the sea.

Korean patent laid-open publication No. 10-2014-0081107 relates to a balance adjusting device for a ship, including: a plate member; and one or more support members for supporting the plate member with respect to the ship and having an expansion structure, wherein the support members are coupled to the plate member such that the plate member can rotate and the support member has a first support member and a second support member for respectively supporting the front side and the rear side of the plate member so as to adjust the inclination of the plate member with respect to a horizontal surface.

The above described prior art is configured to eliminate side effects such as vomiting and motion sickness of passengers by adjusting the trim of a hull, but has a problem that, when the ship rolls and leans to one side by the waves, the loaded cargo thereof is shifted to one side in the ship, resulting in the sinking of the hull into the sea.

Korean registered patent No. 10-1042918 relates to a self-balancing electric vehicle having two wheels, in which a user manipulates a control handle and stands on footsteps and which includes: a main body; footsteps provided to the main body and supporting a user; a control bar for rotating right and left with respect to a rotation shaft as the user on the footsteps manipulates the control handle; a left wheel provided at the left side of the main body; a right wheel provided at the right side of the main body; a motor for rotating both the left wheel and the right wheel; a differential gear unit for transmitting the rotation power of the motor to both the right and left wheels, provided between the left wheel axle of the left wheel and the right wheel axle of the right wheel, and, when one of the right wheel axle or the left wheel axle is applied with a load and thus the rotation speed thereof is decreased, increasing the rotation speed of the other one of the right wheel axle or the left wheel axle; a left-side steering brake provided to the left wheel axle so as to control the rotational speed of the left wheel axle; a right-side steering brake provided to the right wheel axle so as to control the rotational speed of the right wheel axle; a left-side brake control device for controlling the left-side steering brake according to the left rotation of the control bar; and a right-side brake control device for controlling the right steering brake according to the right rotation of the control handle, wherein the left-side brake control device and the right-side brake control device respectively transmit tension to a left-side brake and a right-side brake, and a left-side wire and a right-side wire are respectively connected to the left side and the right side of the control bar.

The above described prior art is configured to provide a balance detecting unit capable of detecting a load of a vehicle between a vehicle body and a damper so as to maintain the balance of the vehicle body by adjusting damping force according to the biased state of the detected load. However, the prior art still has problems that such configuration is limited to passenger cars only and determines the riding comfort of passengers and the abnormality of the vehicle by maintaining self-balance. Therefore, the prior art cannot be applied to a vehicle equipped with a loading box, which is used as a ground transportation apparatus such as a truck.

### DISCLOSURE

### Technical Problem

Accordingly, the present invention has been made in an effort to solve the above-mentioned problems occurring in the prior arts, and it is an objective of the present invention to provide a balance maintaining device for a transport apparatus, which can be provided to the lower portion of a vehicle that is a ground transport apparatus or a ship or a vessel that is a maritime transport apparatus so as to maintain the loaded cargo thereof in balance on an uneven ground surface or rough sea, thereby ensuring safety such that the ship is not tilted to sink, while converting the mechanical energy generated by the vibration of the ship into electric energy so as to separately use the electric energy. It is another objective of the present invention to provide a transport apparatus provided with said balance maintaining device.

### Technical Solution

As a technical concept for achieving the above objective, the present invention provides technical features of a balance maintaining device for a transport apparatus, including: a loading frame formed to be long in the lengthwise direction thereof and having two or more first and second supports, which are respectively formed at both sides of the lower portion of the loading frame; and a lower frame provided at the lower portion of the loading frame and having both upper side portions thereof linked and coupled to the first and second supports, the outside of the lower frame being coupled to a transport apparatus to maintain the loading frame in a horizontal state when the transport apparatus is shaken, wherein first and second support grooves are respectively formed at one side of the lower portion of each of the first and second supports of the loading frame, and two or more first and second coupling parts are respectively formed at both sides of the upper portion of the lower frame and have first and second connection grooves, which correspond to the first and second support grooves and are respectively formed at one side of each of the two or more first and second coupling parts so as to be spaced from each other at a predetermined interval, such that the first support groove and the first connection groove are respectively linked and coupled to each other by a coupling member and the second support groove and the second connection groove are respectively linked and coupled to each other by a coupling member.

### Advantageous Effects

As described hereinabove, according to the balance maintaining device for a transport apparatus and the transport apparatus provided with said balance maintaining device of the present invention as described above, the loading frame on which cargo is loaded can be maintained in a horizontal state even when the transport apparatus is moved on uneven ground or water, thereby providing stable transport and safety against various rollover or sinking accidents caused by leaning to one side and improving cost efficiency by converting the mechanical energy generated from the movement of the lower frame to electrical energy to be used separately.

### DESCRIPTION OF DRAWINGS

FIG. 1 is a front view for showing a preferred embodiment of the present invention.

FIG. 2 is a side view for showing a preferred embodiment of the present invention.

FIG. 3 is an exploded view for showing a preferred embodiment of the present invention.

FIG. 4 is a view for showing an operation state of a preferred embodiment of the present invention.

FIG. 5 is a view for showing a preferred embodiment of the present invention.

FIG. 6 is a view for showing a use state of a preferred embodiment of the present invention.

FIG. 7 is a view for showing a use state of a preferred embodiment of the present invention.

FIG. 8 is an exploded view for showing another preferred embodiment of the present invention.

FIG. 9 is a front view for showing the application of a balance maintaining device of the present invention to a transport apparatus.

FIG. 10 respectively shows a right side view and a left side view of the application of a balance maintaining device of the present invention to a transport apparatus.

FIG. 11 is a front view for showing a lower frame applied to a transport apparatus of the present invention.

FIG. 12 is an exploded view for showing the lower frame applied to a transport apparatus of the present invention.

FIG. 13 is a perspective view for showing the lower frame applied to a transport apparatus of the present invention.

FIG. 14 is a view for showing a lower frame applied to a transport apparatus of the present invention.

FIG. 15 is a view for showing an operation state of a preferred embodiment of the present invention.

FIG. 16 is a perspective view for showing another embodiment of the present invention, and

FIG. 17 is an exploded view for showing another embodiment of the present invention.

[Explanation of essential reference numerals in drawings]

| | | | |
|---|---|---|---|
| 10: | transport apparatus | 101: | loading box |
| 100: | loading frame | 111: | first support groove |
| 110: | first support | 121: | second support groove |
| 112: | protrusion part | 200: | lower frame |
| 120: | second support | 220: | second coupling part |
| 122: | protrusion part | | |
| 130: | connection member | | |
| 210: | first coupling part | | |
| 211: | first connection groove | | |
| 212: | protrusion part | | |
| 221: | second connection groove | | |
| 222: | protrusion part | | |
| 300: | coupling member | | |
| 320: | groove part | | |
| 400: | power conversion device | | |
| 500: | battery part | | |
| 600: | driving motor | | |
| 700: | battery part | | |
| 800: | control unit | | |
| g: | ground surface | | |

### MODE FOR INVENTION

According to the present invention, there are provided a balance maintaining device for a transport apparatus and a transport apparatus provided with said balance maintaining device, in which, when a transport apparatus 10 loads cargo and moves on an uneven ground surface or sea, passengers as well as cargo loaded in a loading frame 100 can be kept in balance without shaking to prevent the cargo from escaping, the gravity point of the loaded cargo is moved to a lower portion of the transport apparatus so as to ensure safe operation, and the power of the ship is generated by the vibration of the ship due to the influence of waves.

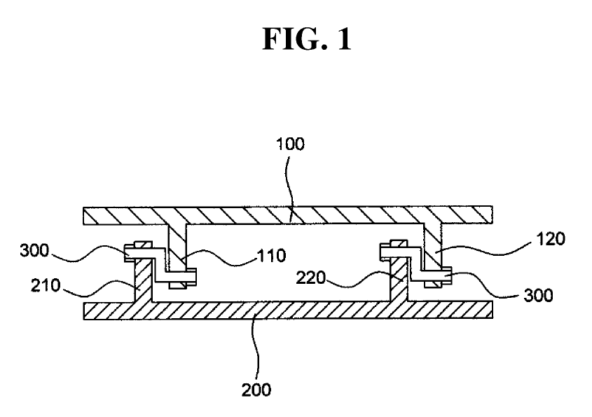

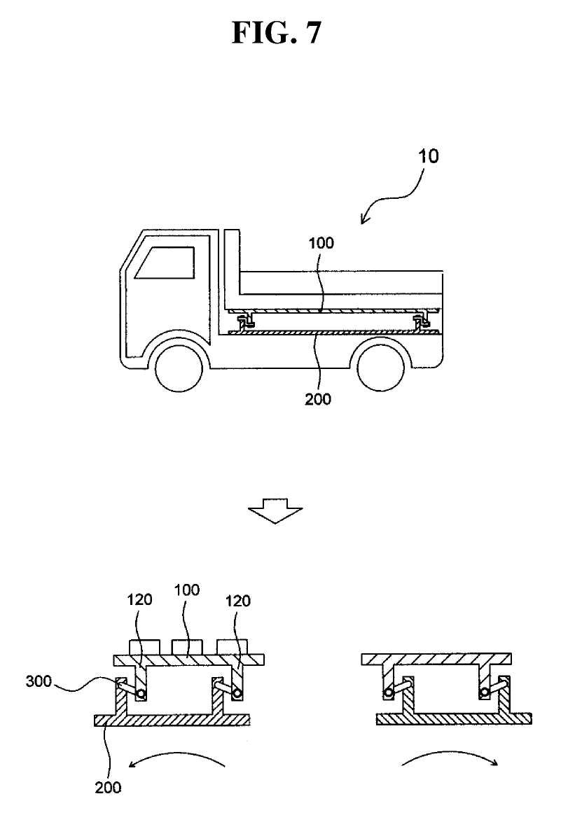

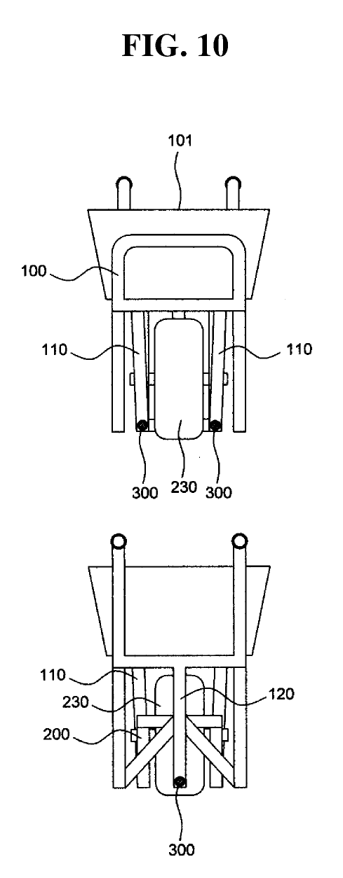

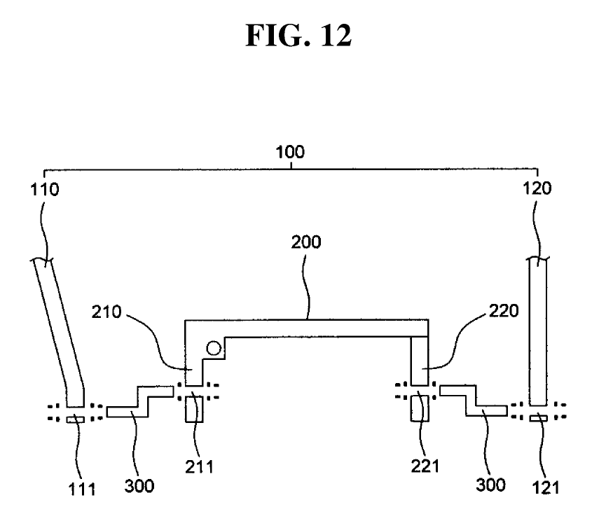

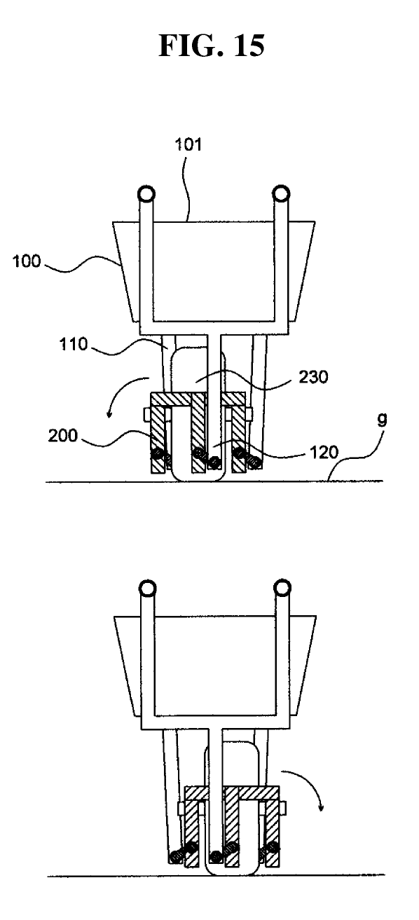

Now, preferred configurations and operations of the present invention for achieving the above objectives will be described with respect to the accompanying drawings by referring to FIG. 1 to FIG. 17 hereinafter.

First, before describing the present invention, explaining the configuration as shown in FIG. 1 to FIG. 4, a loading frame 100 is formed to be long in the lengthwise direction thereof and has two or more first and second supports 110, 120, which are respectively formed at both sides of the lower portion of the loading frame 100, and a lower frame 200 is provided at the lower portion of the loading frame 100, and has both upper side portions, which are linked and coupled to the first and second supports 110, 120, wherein the outside of the lower frame 200 is coupled to a transport apparatus 10 so as to maintain the loading frame 100 in a horizontal state when the transport apparatus 10 is shaken.

That is, the force of the loading frame 100 is transmitted to a lower portion by the weight of the cargo loaded on the upper portion of the loading frame 100 such that only the lower frame 200 moves while the loading frame 100 is maintained in a horizontal state, thereby preventing the escape of the cargo loaded in a loading box and ensuring safety.

The loading frame 100 is formed to load various cargoes thereon and may have four surfaces protruded upwards so as to prevent the loaded cargo from escape through the side portions of the loading frame 100, wherein the loading frame 100 is shown to be formed long in the lengthwise direction.

The lower frame 200 has an upper portion formed with first and second coupling part 210, 220 to be linked and coupled respectively to the first and second supports 110 and 120 of the loading frame 100, such that the lower frame 200 maintains the loading frame 100, which is provided above the lower frame 200 and linked and coupled to the lower frame 200, in a horizontal state and prevents the escape of the cargo loaded on top of the loading frame 100, by pushing the loading frame 100 downwards by the weight of the cargo.

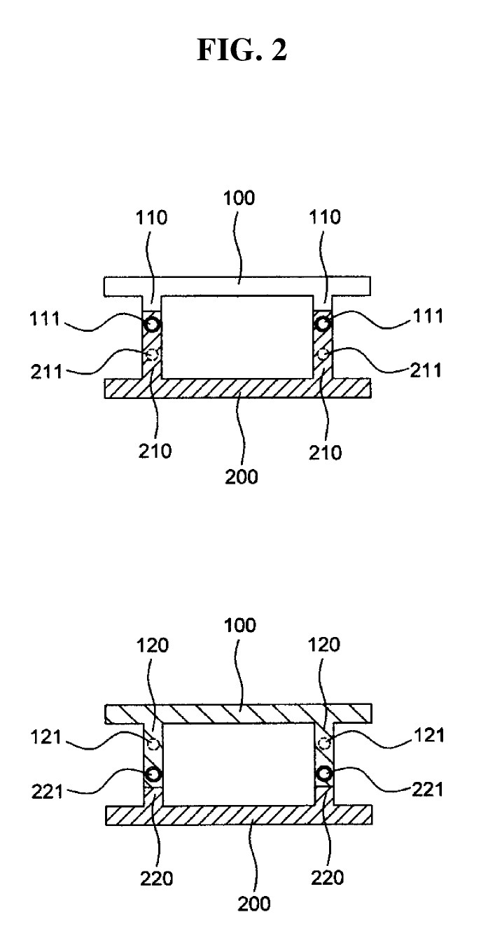

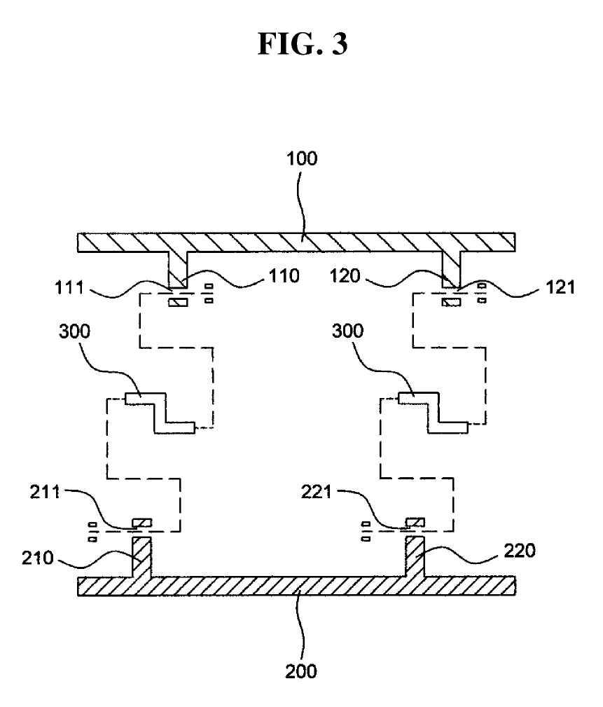

Explaining the balance maintaining device for a transport apparatus according to the present invention as configured above in more detail, as shown in FIG. 2 and FIG. 3, first and second support grooves 111, 121 are respectively formed at one side of the lower portion of each of the first and second supports 110, 120 of the loading frame 100, and two or more first and second coupling parts 210, 220 are respectively formed at both sides of the upper portion of the lower frame 200 and have first and second connection grooves 211, 221, which correspond to the first and second support grooves 111, 121 and are respectively formed at one side of each of the two or more first and second coupling parts 210, 220 so as to be spaced from each other at a predetermined interval, such that the first support groove 111 and the first connection groove 211 are respectively linked and coupled to each other by a coupling member 300 and the second support groove 121 and the second connection groove 221 are respectively linked and coupled to each other by a coupling member 300.

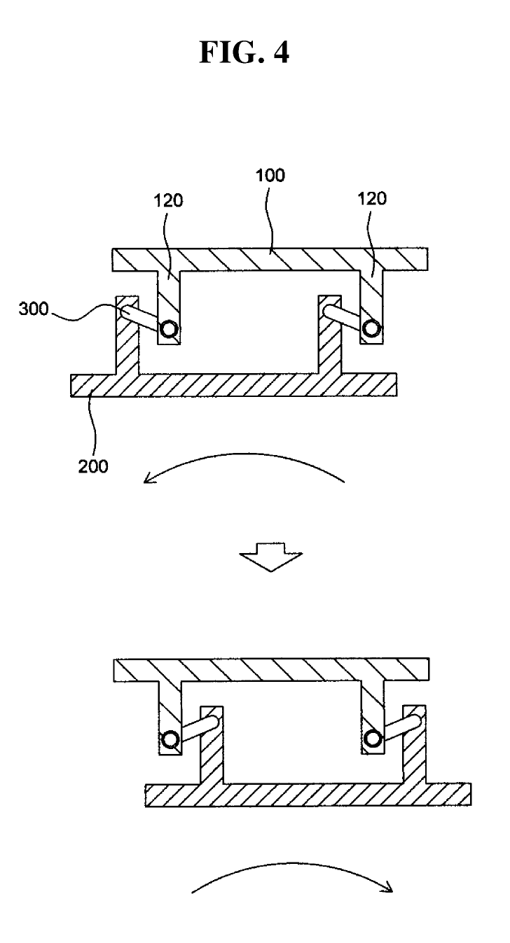

That is, as shown in FIG. 4, the both lower side portions of the stacking frame 100 and the both upper side portions of the upper part of the lower frame 200 are respectively linked and coupled to each other by the coupling members 300 and moved in the right and left directions with respect to the first and second support grooves 111, 121, wherein the loading frame 100 can be maintained in a horizontal state by the weight of the cargo loaded on top of the loading frame 100.

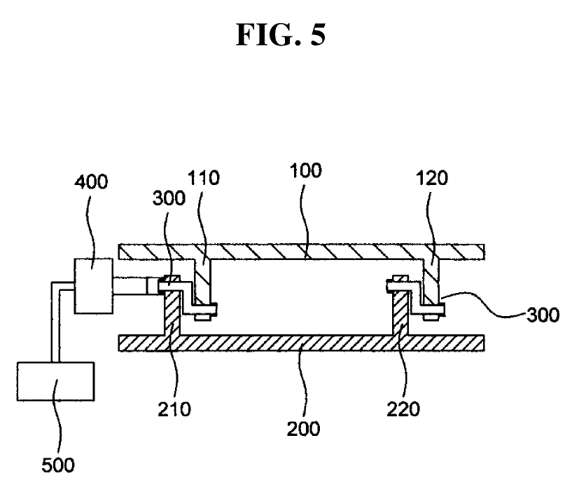

Meanwhile, as shown in FIG. 5, a power conversion device 400 and a battery part 500 are connected to one side of the coupling member 300 such that the power conversion device 400 converts mechanical energy generated by the movement of the lower frame 200 into electrical energy and the battery part 500 stores the electrical energy converted by the power conversion device 400. The mechanical energy generated by the right and left movement of the lower frame 200 can be converted into electrical energy through the power conversion device 400 and stored in the battery part 500 connected to the power conversion device 400 so that the battery part 500 can be used for various purposes.

The balance maintaining device for a transport apparatus according to the present invention as described above can be applied to and used in various transport apparatuses.

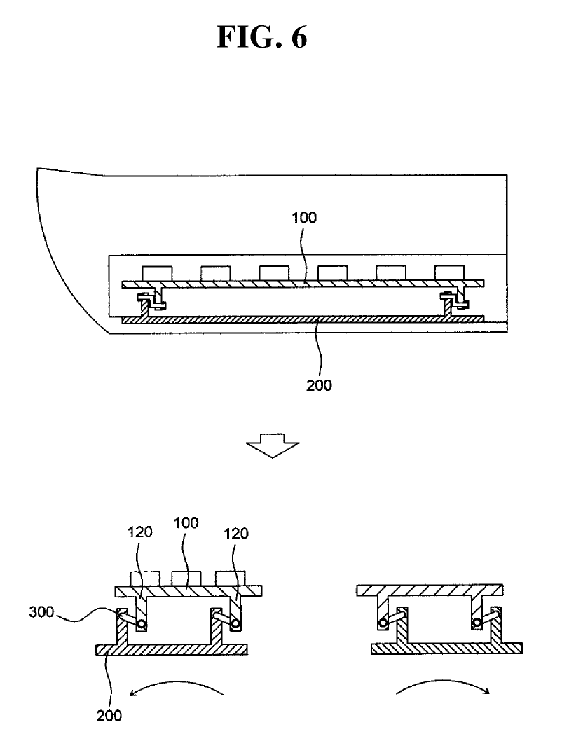

First, in the case of a ship used as a maritime transport apparatus 10, as shown in FIG. 6, a lower frame 200 is connected to the hull of the ship and a loading frame 100 is formed to be loaded with various cargoes in the operation of the ship, wherein the loading frame 100 is not connected to the hull of the ship but linked and coupled to the lower frame 200, which is connected to the hull of the ship, and the various cargoes are loaded on top of the loading frame 100.

In this case, even though the hull is moved due to external factors such as waves at the sea and thus the lower frame 200 coupled to the hull is also moved, the loading frame 100 can be maintained in a horizontal state by the cargo loaded thereon such that the hull can be prevented from being inclined to one side due to the cargo and thus prevented from sinking, thereby ensuring safety at sea.

Conventionally, a balance maintaining device including buoyancy members at both sides of the hull of a ship has been used in order to maintain the equilibrium of the ship. However, when the whole ship moves due to external factors such as waves, a leaning phenomenon of the ship may be generated since the cargo loaded in the ship moves in one side direction, causing the problem that the ship is completely inclined in one side direction due to the weight of the cargo and thus sunk in the sea.

In recent years, ships, which have been operated at sea, are tilted in one side direction by the external factors such as high waves and sunk by the shifting phenomenon of the cargo, which has been loaded on the ground surface, resulting in a lot of casualties simultaneously with huge economic loss

However, if the ship is equipped with a balance maintaining device according to the present invention, only the hull is moved by the waves at the sea but the loading box, in which the cargo is loaded, can be maintained in a horizontal state, such that the hull can be prevented from leaning and sinking to one side due to such a cargo shifting phenomenon.

In addition to the loading box, the boarding space to be occupied by passengers can be configured in the same manner as the loading frame 100 to be loaded with cargo, so that the passengers and the cargo can always be kept in a horizontal state, thereby providing comfort.

Meanwhile, explaining the balance maintaining device for a transport apparatus according to the present invention in more detail, for example, with respect to vehicles used as ground transport apparatuses 10 in addition to ships, as shown in FIG. 2 and FIG. 3, the balance maintaining device for a transport apparatus according to the present invention is positioned at the lower portion of a loading box of a typical 1 ton truck, wherein the lower frame 200 is connected and coupled to the vehicle body of the truck and the loading frame 100 is coupled to the loading box of the truck.

Herein, various kinds of cargo are loaded on the loading box coupled to the upper portion of the transport apparatus 10, and a load due to the weight of the cargo is transferred to the loading frame 100 as it is such that, when the vehicle moves on an uneven ground surface during traveling, the loading box can be maintained in a horizontal even if the vehicle body is moved to the left or right.

In addition, the balance maintaining device for a transport apparatus according to the present invention will be explained, for example, with respect to a bicycle, which is a moving means and can carry a simple load. Although not shown, such a bicycle includes a bicycle main body frame, which is provided with a handle for a driver to hold by hand, a saddle for the driver to directly sit thereon, and a space part formed at the rear side of the saddle such that a person can sit thereon or a load can be placed thereon, wherein wheels are axially coupled at both sides of the lower portion of the bicycle main body frame.

If the balance maintaining device for a transport apparatus according to the present invention is applied to this bicycle, the loading frame 100 is formed to be additionally connected to the loading space of the bicycle, on which a load can be placed, and the lower frame 200 is connected to the bicycle main body frame.

In this case, when the driver moves on an uneven ground surface during the riding of the bicycle, only the lower frame 200 is moved to the right and left, and the weight of both the driver and the load can be kept in a horizontal state.

Meanwhile, it is also conceivable to vary the structure of the loading frame 100, the lower frame 200 and the coupling member 300 respectively linked to the loading frame 100 and the lower frame 200.

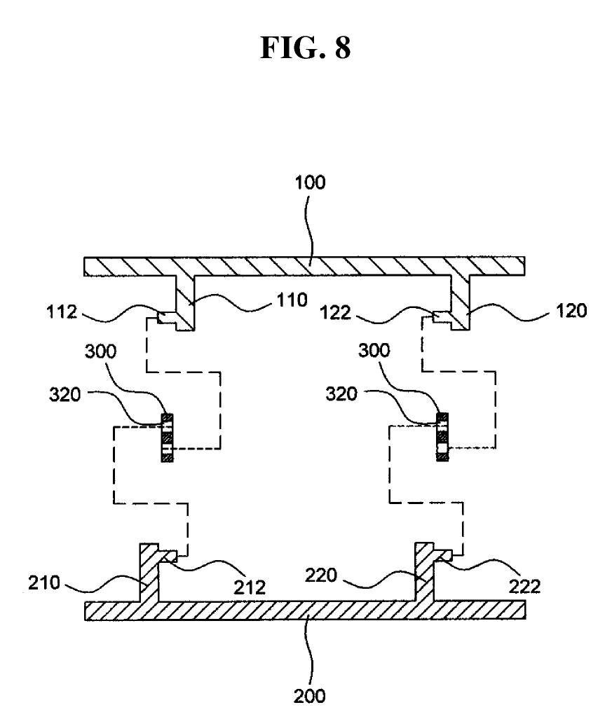

As shown in FIG. 8, a balance maintaining device for a transport apparatus may include a loading frame 100 formed to be long in the lengthwise direction thereof and having two or more first and second supports 110, 120, which are respectively formed at both sides of the lower portion of the loading frame 100 and have protrusion parts 112, 122 respectively formed at one side of each of the first and second supports 110, 120, a lower frame 200 provided at the lower portion of the loading frame 100 and having two or more first and second coupling parts 210, 220, which are respectively formed at both sides of the upper portion of the lower frame 200 and have protrusion parts 212, 222 respectively formed at one side of each of the first and second coupling parts 210, 220, and a coupling member 300 having groove parts 320, into which each of the protrusion parts 112, 122 and each of the protrusion parts 212, 222 is respectively fitted, wherein the loading frame 100 can be maintained in a horizontal state when a transport apparatus 10 is shaken.

That is, the protrusion parts 112, 122 are respectively formed to be protruded in one side direction from the first and second supports 110, 120 of the loading frame 100, the protrusion parts 212, 222 are formed to be protruded in one side direction from the first and second coupling parts 210, 220 of the lower frame 200, and the coupling member 300 is formed with the groove parts 320, into which the protrusion parts 112, 122, 212, 222 can be fitted, so that the coupling member 300 can be engaged with the protrusion parts 112, 122, 212, 222.

Meanwhile, the coupling member 300 is tightened by elements such as typical nuts so as not to be detached from the protrusion parts 112, 122, 212, 222, thereby avoiding the escape thereof. In addition, when the protrusion parts 112, 122, 212, 222 are formed in plural numbers, it is preferable that the number of the coupling member 300 is also adjusted according to the number of the protrusion parts 112, 122, 212, 222.

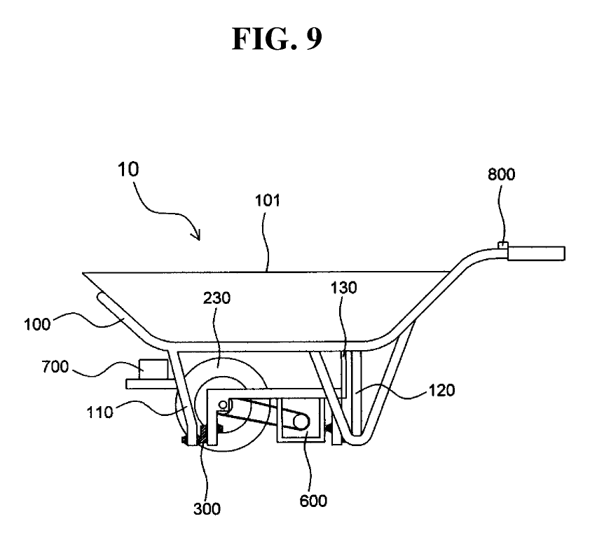

Herein, the balance maintaining device for a transport apparatus according to the present invention described as above may be applied to and used in a transport apparatus such as a wagon and the configuration thereof will be described with reference to FIG. 9 to FIG. 17 hereinafter.

First, as shown in FIG. 9 to FIG. 11, a transport apparatus provided with a balance maintaining device, includes a loading frame 100 having a loading box 101 provided at the upper portion thereof, one pair of first supports 110 extended at one side of the lower portion thereof, and a second support 120 extended at the other side of the lower portion thereof, and a lower frame 200 provided between the first and second supports 110, 120 and having first coupling parts 210, which are extended downwards at one side of the lower frame such that a wheel 230 is axially provided between inner portions thereof, which face each other in the corresponding directions, and a second coupling part 220, which is extended downwards at the other side of the lower frame, wherein the lower frame is linked and coupled respectively to one side of each of the first support 110 and the second support 120.

As for the loading frame 100, the upper portion of the loading frame 100 are bent upwards at both sides so as to encompass the outside of the loading box 101 such that the loading box 101 is provided and fixed on top of the upper portion of the loading frame 100, wherein a handle bar is provided to the end of one of the upwardly bent portion such that a user can directly hold the handle bar.

Herein, a first support groove 111 is formed at one side of the lower portion of the first support 110, a second support groove 121 is formed at one side of the lower portion of the second support 120, first and second connection grooves 211, 221 are respectively formed at both sides of the lower frame 200 so as to correspond to the first and second support grooves 111, 121 and be spaced upwards from the first and second support grooves 111, 121 at a predetermined interval such that one pair of the first support groove 111 and the first connection groove 211 are linked and coupled to each other by a coupling member 300 and the second support groove 121 and the second connection groove 221 are linked and coupled to each other by a coupling member 300.

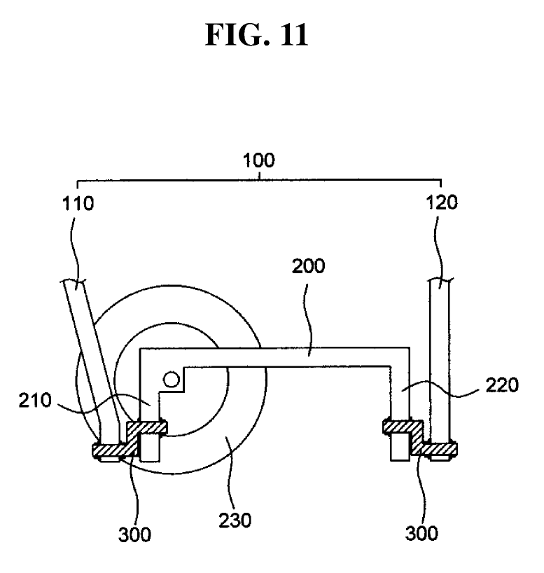

That is, as shown in FIG. 11 or FIG. 12 or FIG. 15, the coupling members 300 are movably linked and coupled so that, when the wheel 230 moves on an uneven ground surface, the coupling members 300 naturally move in the same direction with respect to the first and second support grooves 111, 121, that is, in one side direction or the other side direction and thus an impact is not transmitted to the loading frame 100 and the loading box 101, which is provided on top of the loading frame 100. Therefore, the loading frame 100 can be maintained in a horizontal (balanced) state.

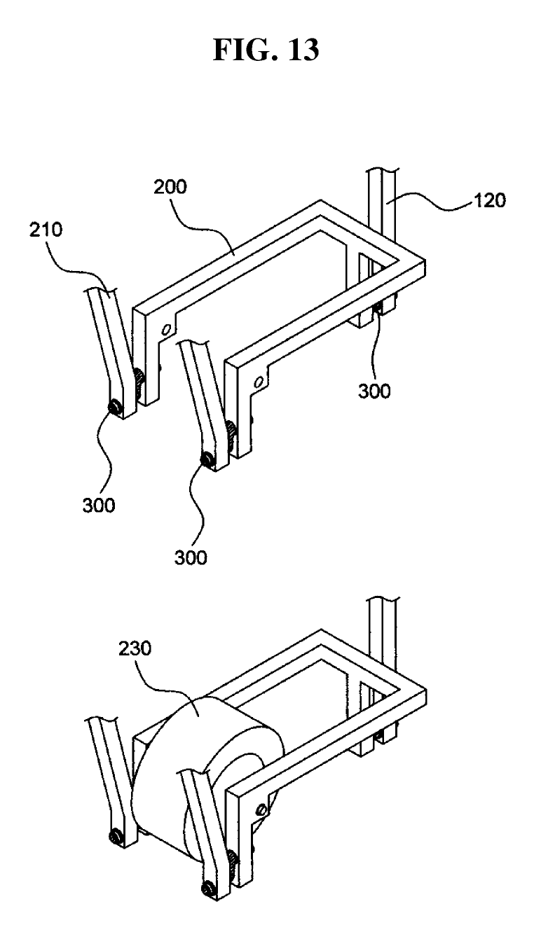

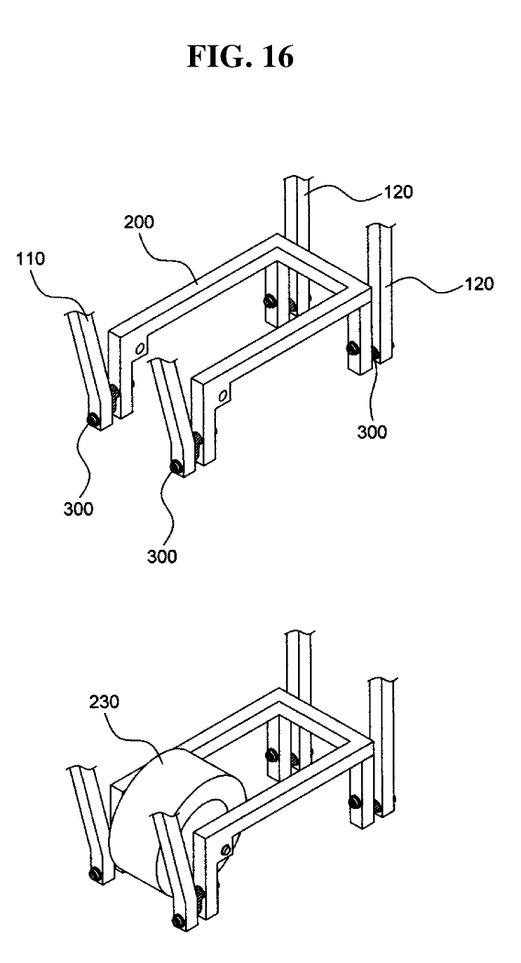

In addition, even though the loading frame 100 is shown as being formed of one pair of first supports 110 and one second support 120 in FIG. 13, it is also conceivable that the loading frame 100 is formed of one pair of first supports 110 and one pair of second supports 120, wherein the lower frame 200 is also formed of one pair of second connection grooves 221 at one side thereof, which is linked and coupled to the second supports 120, as shown in FIG. 16.

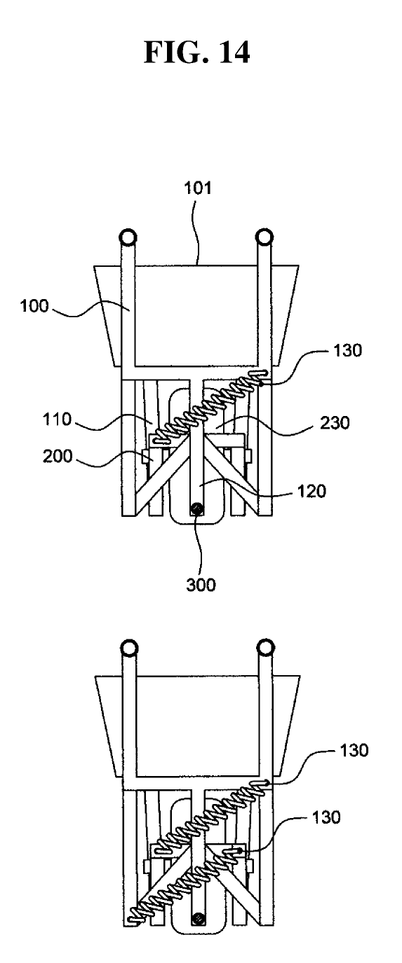

Meanwhile, as shown in FIG. 14, a connection member 130 is diagonally provided to one side of the lower frame 200 and one side of the loading frame 100 so as to maintain more stable balance when cargo is loaded on the loading box 101, wherein a plurality of connection members 130 may be formed and used.

In addition, as shown in FIG. 9, a driving motor 600 is provided at one side of the loading frame 100 so as to be connected to the axle of the wheel 230 by a chain or a belt, a battery part 700 is provided at the other side of the loading frame 100 and spaced from the driving motor 600 at a predetermined interval so as to supply electricity to the driving motor 600, and a control unit 800 is provided at one side of the upper portion of the loading frame 100 so as to control the driving motor 600, thereby promoting convenience.

Besides, it is also possible to vary the coupling structure of the loading frame 100 and the lower frame 200.

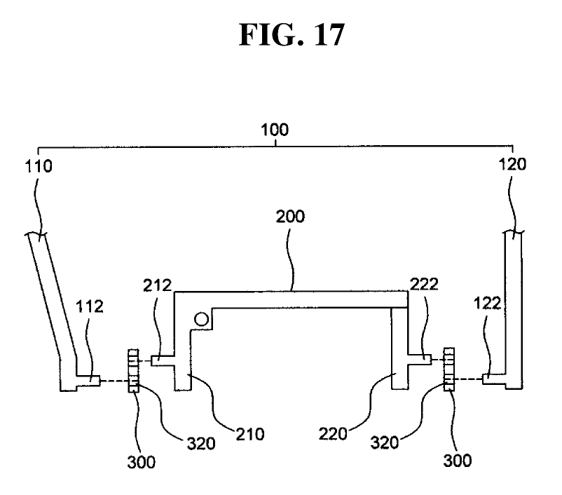

As shown in FIG. 9 or FIG. 17, a transport apparatus provided with a balance maintaining device, includes a loading frame 100 having a loading box 101 provided at the upper portion thereof, one pair of first supports 110 extended at one side of the lower portion thereof, and a second support 120 extended at the other side of the lower portion thereof, the first and second supports 110, 120 having a plurality of protrusion parts 112, 122 respectively formed at one side of each of the first and second supports 110, 120, and a lower frame 200 provided between the first and second supports 110, 120 and having a wheel 230 axially provided between inner portions thereof, which face each other in the corresponding directions, and protrusion parts 212, 222 respectively formed at both lower side portions of the lower frame 200 in the diagonal direction of one side of the first support 110 and in the diagonal direction of one side of the second support 120 such that coupling members 300 are respectively fitted with the protrusion parts 112, 122 of the first supports 110 and the protrusion parts 212, 222 of the second supports 120.

According to the balance maintaining device for a transport apparatus of the present invention, the loading frame, on which cargo is loaded, can be maintained in a horizontal state even when the transport apparatus moves on uneven ground or water, thereby ensuring stable transport and safety against various rollover or sinking accidents caused by leaning to one side. In addition, mechanical energy generated from the movement of the lower frame can be converted into electrical energy to be used separately, thereby improving cost efficiency.

1. A balance maintaining device for a transport apparatus, comprising:
a loading frame (100) formed to be long in the lengthwise direction thereof and having two or more first and second supports (110, 120), which are respectively formed at both sides of the lower portion of the loading frame (100); and
a lower frame (200) provided at the lower portion of the loading frame (100), and having both upper sides thereof linked and coupled to the first and second supports (110, 120),
wherein the outside of the lower frame (200) is coupled to a transport apparatus (10) so as to maintain the loading frame (100) in a horizontal state when the transport apparatus (10) is shaken.

2. The balance maintaining device for a transport apparatus according to claim 1, wherein first and second support grooves (111, 121) are respectively formed at one side of the lower portion of each of the first and second supports (110, 120) of the loading frame (100), and two or more first and second coupling parts (210, 220) are respectively formed at both sides of the upper portion of the lower frame (200) and have first and second connection grooves (211, 221), which correspond to the first and second support grooves (111, 121) and are respectively formed at one side of each of the two or more first and second coupling parts (210, 220) so as to be spaced from each other at a predetermined interval, such that the first support groove (111) and the first connection groove (211) are respectively linked and coupled to each other by a coupling member (300) and the second support groove (121) and the second connection groove (221) are respectively linked and coupled to each other by a coupling member (300).

3. The balance maintaining device for a transport apparatus according to claim 2, wherein a power conversion device (400) and a battery part (500) are connected to one side of the coupling member (300) such that the power conversion device (400) converts mechanical energy generated by the movement of the lower frame (200) into electrical energy and the battery part (500) stores the electrical energy converted by the power conversion device (400).

4. A balance maintaining device for a transport apparatus, comprising:
a loading frame (100) formed to be long in the lengthwise direction thereof and having two or more first and second supports (110, 120), which are respectively formed at both sides of the lower portion of the loading frame (100) and have protrusion parts (112, 122) respectively formed at one side of each of the first and second supports (110, 120);
a lower frame (200) provided at the lower portion of the loading frame (100) and having two or more first and second coupling parts (210, 220), which are respectively formed at both sides of the upper portion of the lower frame (200) and have protrusion parts (212, 222) respectively formed at one side of each of the first and second coupling parts (210, 220); and
a coupling member (300) having groove parts (320), into which the respective protrusion parts (112, 122) and the protrusion parts (212, 222) are respectively fitted,
wherein the loading frame (100) is maintained in a horizontal state when a transport apparatus (10) is shaken.

5. A transport apparatus provided with a balance maintaining device, comprising:
a loading frame (100) having a loading box (101) provided at the upper portion thereof, one pair of first supports (110) extended at one side of the lower portion thereof, and a second support (120) extended at the other side of the lower portion thereof; and
a lower frame (200) provided between the first and second supports (110, 120) and having a wheel (230) axially provided between inner portions, which face each other in the corresponding directions, and both lower side portions respectively linked and coupled to one side of each of the first support (110) and the second support (120).

6. The transport apparatus provided with a balance maintaining device according to claim 5, wherein a first support groove (111) is formed at one side of the lower portion of the first support (110), a second support groove (121) is formed at one side of the lower portion of the second support (120), first and second connection grooves (211, 221) are respectively formed at both sides of the lower frame (200) so as to correspond to the first and second support grooves (111, 121) and be spaced upwards from the first and second support grooves (111, 121) at a predetermined interval such that one pair of the first support groove (111) and the first connection groove (211) are linked and coupled to each other by a coupling member (300) and the second support groove (121) and the second connection groove (221) are linked and coupled to each other by a coupling member (300).

7. The transport apparatus provided with a balance maintaining device according to claim 6, wherein a pair of second supports (120) are provided and, when the pair of second supports (120) are provided, a pair of second connection grooves (221) are formed at portions of the lower frame (200) portion, which are linked and coupled to the second supports (120).

8. The transport apparatus provided with a balance maintaining device according to claim 5, wherein a connection member 130 is connected to one side of the lower frame (200) and one side of the loading frame (100) so as to maintain balance when cargo is loaded on the loading box (101).

9. The transport apparatus provided with a balance maintaining device according to claim 8, wherein a plurality of the connection members (130) are provided.

10. The transport apparatus provided with a balance maintaining device according to claim 5, wherein a driving motor (600) is provided at one side of the loading frame (100) so as to be connected to the axle of the wheel (230) by a chain or a belt, a battery part (700) is provided at the other side of the loading frame (100) and spaced from the driving motor (600) at a predetermined interval so as to supply electricity to the driving motor (600), and a control unit (800) is provided at one side of the upper portion of the loading frame (100) so as to control the driving motor (600).

11. A transport apparatus provided with a balance maintaining device, comprising:
a loading frame (100) having a loading box (101) provided at the upper portion thereof, one pair of first supports (110) extended at one side of the lower portion thereof, and a second support (120) extended at the other side of the lower portion thereof, the first and second supports (110, 120) having a plurality of protrusion parts (112, 122) respectively formed at one side of each of the first and second supports (110, 120); and
a lower frame (200) provided between the first and second supports (110, 120) and having a wheel (230) axially provided between inner portions thereof, which face each other in the corresponding directions, and protrusion parts (212, 222) respectively formed at both lower side portions in the diagonal direction of one side of the first support (110) and in the diagonal direction of one side of the second support (120) such that coupling members (300) are respectively fitted with the protrusion parts (112, 122, 212, 222) of the first and second supports (110, 120).
